(19) United States
(12) Patent Application Publication
(10) Pub. No.: US 2025/0023048 A1
(43) Pub. Date: Jan. 16, 2025

(54) ACRYLATE BINDER

(71) Applicant: SOLVAY SPECIALTY POLYMERS ITALY S.P.A., Bollate (Milano) (IT)

(72) Inventors: Jean Noël Tourvieille, Blanquefort (FR); Steven Meeker, Gazinet-Cestas (FR); Stefano Mauri, Giussano (IT); Maurizio Biso, Milano (IT); Wojciech Bzducha, Lyon (FR); Jean-Christophe Castaing, Sèvres (FR); David James Wilson, La Pomarede (FR); Jean Raoul Gomez, Boulogne-Billancourt (FR)

(73) Assignee: SOLVAY SPECIALTY POLYMERS ITALY S.P.A., Bollate (Milano) (IT)

(21) Appl. No.: 18/712,625

(22) PCT Filed: Nov. 18, 2022
(86) PCT No.: PCT/EP2022/082490

§ 371 Date: May 22, 2024

(30) Foreign Application Priority Data
Nov. 22, 2021 (EP) 21306620.2

(51) Int. Cl. H01M 4/62; H01M 4/04; H01M 10/052

(52) U.S. Cl. CPC H01M 4/622; H01M 4/0404; H01M 4/0471; H01M 10/052; H01M 2220/30

(57) ABSTRACT

The present invention relates to a polymer for a non-aqueous electrolyte rechargeable battery, an electrode slurry for a rechargeable battery and a rechargeable battery comprising the same.

### CROSS REFERENCE TO PREVIOUS APPLICATIONS

This application claims priority to European application No. 21306620.2 filed on 22 Nov. 2021, the whole content of this application being incorporated herein by reference for all purposes.

### TECHNICAL FIELD

The present invention relates to a polymer for use in non-aqueous electrolyte rechargeable battery, an electrode slurry for a rechargeable battery and a rechargeable battery comprising the same.

### BACKGROUND ART

Battery for EV cars need to keep improving in terms of energy density to remove range anxiety and allow broader and faster adoption. Adoption of Silicon anode is one of the most powerful techno strategies to increase battery capacity and therefore energy density. Silicon (Si) has been extensively studied as anode active material due to its high theoretical specific capacity (3600 mAh/g), much higher than the incumbent anode active material, graphite (<400 mAh/g).

However, in practical application, Si is highly challenging because during lithium insertion and extraction (charge and discharge of the battery) a dramatic volume change hasten mechanical fracture of the electrode causing loss of electric contact and resulting in continuous electrolyte decomposition at the active material surface. One widely adopted strategy in the battery market is to use a limited amount of silicon (<10%) mixed with graphite as active material. This strategy mitigates the detrimental impact of silicon on electrode mechanical integrity; however, the achieved improvement in energy density, proportional to the amount of silicon, is quite limited. The binder, typically an organic polymer, serves as the connective matrix that maintains contact between active materials throughout the anode layer and with the current collector onto which the anode is deposited during fabrication.

The binder currently used at anode, thus with active material graphite comprising low Si amount, is a combination of a rubber (SBR) with a cellulose derivative (CMC). Said binder is not adequate for silicon-rich anodes (silicon amount >10%) because it is not sufficiently rigid. More efforts to achieve Si-rich anodes (>10%) are still needed especially on binder design, because the binder can play a key role in accommodating volume change and prevent electrical contact loss between Si particles. In fact, it is believed that a robust polymeric binder, capable to interact reversibly with the surface of silicon, can inhibit mechanical fracturing of the anodes during cycling.

It is generally accepted that chemical functionalities conducive to favorable surface interactions with both the active material and current collector substrate are necessary. Furthermore, chemical compatibility with the liquid electrolyte and other additives is a prerequisite to any binder irrespective of active material compositions.

There are many approaches being pursued to develop next generation binders to accommodate silicon anodes.

In this context, polycarboxylate binders and derivatives are being pursued, including polyacrylic acids, polyamic acids, polyacrylamides, and other hydrogen bonding structures.

Miranda, A. et al. (“A Comprehensive Study of Hydrolyzed Polyacrylamide as a Binder for Silicon Anodes” Appl. Mater. Interfaces, 2019, 11, 44090-44100) disclose the use of partially hydrolyzed polyacrylamide in the preparation of composite silicon anodes having good adhesion, high strength and high electrochemical storage capacity.

WO 2022/013070 discloses that certain modified polycarboxylates polymers, especially modified polyacrylic acids including acrylamide monomers, allow preventing degradation of silicon-rich anodes. The distribution of the acrylic acid (AA) and acrylamide (AM) monomers in said polymers grants excellent adhesion to metal in comparison with lithiated polyacrylic acid (PAA). Moreover, the anodes obtained by using said polymers as binders show good cycling stability, which is related to the higher cohesion that the polymers have in comparison with SBR/CMC systems.

Such binders types effectively make hydrogen bonding between pendant acid groups and silanol groups on the silicon surface and this addresses the silicon volume change issue but they have no favorable rheology and dispersant behaviors. So they need additives like carboxymethylcellulose (CMC), a well know rheology modifier and dispersant, for effective electrode preparation.

The Applicant has unexpectedly found that certain polycarboxylates polymers, properly lithiated, show surprisingly excellent dispersant properties, and are therefore suitable for anode slurry preparation, even in the absence of dispersants.

### SUMMARY OF INVENTION

It is an object of the invention an acrylic polymer dispersant [polymer (P)] for dispersing powder particles in aqueous electrode-forming compositions, characterized by comprising:
(A) recurring units derived from at least one α,β-ethylenically unsaturated carboxylic acid monomer [monomer (AA)] in neutralized form; and
(B) recurring units derived from at least one (meth)acrylamide monomer [monomer (AM)]
wherein the polymer (P) has weight average molecular weight of about 500 kDa to 10000 kDa.

The Applicant has surprisingly found that polymer (P) dissolved in water can be suitably used as binder for the preparation of electrode-forming compositions thanks to its excellent dispersing ability, far better than that of CMC or of blends of CMC with acrylic polymers.

The polymer (P) in fact leads to stable slurry with no sedimentation for over 2 days without the use of a rheology modifier.

In another object, the present invention thus provides an aqueous electrode-forming composition [composition (Comp)] for use in the preparation of electrodes for electrochemical devices, said composition being characterized by consisting of:
a) at least one polymer (P) as above defined;
b) an electrode active material,
c) an aqueous solvent, and
d) optionally at least one electroconductivity-imparting additive.

In another object, the present invention provides a process for preparing an electrode [electrode (E)], said process comprising:
(i) providing a metal substrate having at least one surface;
(ii) providing a composition (Comp) as above defined;
(iii) applying the composition (Comp) provided in step (ii) onto the at least one surface of the metal substrate provided in step (i), thereby providing an assembly comprising a metal substrate coated with said composition (Comp) onto the at least one surface;
(iv) drying the assembly provided in step (iii);
(v) submitting the dried assembly obtained in step (iv) to a compression step to obtain the electrode (E) of the invention.

In a further aspect, the present invention pertains to the electrode [electrode (E)] obtainable by the process of the invention.

In still a further object, the present invention pertains to an electrochemical device comprising at least one electrode (E) of the present invention.

### BRIEF DESCRIPTION OF DRAWINGS

FIG. 1 are optical microscopy images of formulations 1 to 3 of the examples.

### DETAILED DESCRIPTION

In the context of the present invention, the term “percent by weight” (wt. %) indicates the content of a specific component in a mixture, calculated as the ratio between the weight of the component and the total weight of the mixture. When referred to the total solid content (TSC) of a liquid composition, weight percent (wt. %) indicates the ratio between the weight of all non-volatile ingredients in the liquid.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

As known in the art, an electrode forming composition is a composition of matter, typically a fluid composition, wherein solid components are dissolved or dispersed in a liquid, which can be applied onto a metallic substrate and subsequently dried thus forming an electrode wherein the metallic substrate acts as current collector. Electrode forming compositions typically comprise at least an electro active material and at least a binder.

The electrode-forming composition [composition (Comp)] of the present invention comprises at least one polymer (P), which functions as a binder.

### The Polymer (P)

Polymer (P) is characterized by comprising recurring units derived from at least one α,β-ethylenically unsaturated carboxylic acid monomer [monomer (AA)] in neutralized form and recurring units derived from at least one (meth)acrylamide monomer [monomer (AM)].

The at least one α,β-ethylenically unsaturated carboxylic acid monomer (AA) is preferably a compound of formula (I):

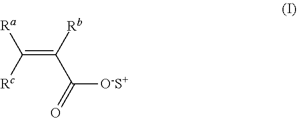

wherein R^{a}, R^{b} and R^{c}, equal to or different from each other, are independently selected from a hydrogen atom and a C₁-C₃ hydrocarbon group, and wherein S is a monovalent cation, preferably an alkaline metal salt.

More preferably, monomer (AA) is a compound of formula (I) as above defined, that is selected from the group consisting of salts of: acrylic acid, methacrylic acid, Sipomer® B-CEA (sold by Solvay), ethacrylic acid, crotonic, methyl (meth)acrylic acid, ethyl (meth)acrylic acid, propyl (meth)acrylic acid, isopropyl (meth)acrylic acid, n-butyl (meth)acrylic acid, 2-ethylhexyl (meth)acrylic acid, n-hexyl (meth)acrylic acid and n-octyl (meth)acrylic acid.

The (meth)acrylamide monomer [monomer (AM)] is preferably a compound of formula (II):

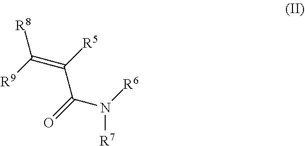

wherein
R⁵ represents a hydrogen atom or a methyl group,
R⁶ and R⁷ being the same or different from each other, may be selected from a hydrogen atom or from a linear or branched alkyl group having 1 to 6 carbon atoms,
R⁸ and R⁹, being the same or different from each other, may be selected from a hydrogen atom, from a linear or branched alkyl group having 1 to 6 carbon atoms, a carboxylic group or an amide group.

The monomer (AM) is preferably selected from the group consisting of (meth)acrylamides or N-substituted (meth)acrylamide such as N-alkyl acrylamides, N,N-dialkylacrylamides.

Polymer (P) may optionally include recurring units derived from at least one ethylenically unsaturated monomer (M), different from monomer (AA) and from monomer (AM), provided the total amount of monomer (AA) and/or monomer (AM) is at least 60% by moles with respect to the total moles of recurring units of polymer (P).

Monomer (M) can suitably be selected from the group consisting of:
monomer (M1), being an ethylenically unsaturated monomer carrying an unsaturated heterocyclic group having at least one nitrogen atom, said monomer (M1) having the formula (III) below:

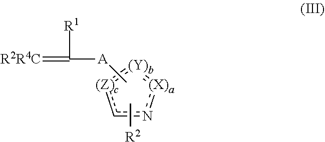

wherein:
R¹ is H or an alkyl group, wherein the alkyl group is preferably a methyl group;
R² is H or an alkyl group;
R³ and R⁴ being the same or different from each other, may be selected from a hydrogen atom or from a linear or branched alkyl group having 1 to 6 carbon atoms;
A is a linkage selected from the group consisting of:
   a single covalent bond; and
   a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond;
monomer (M2), different from monomer (AA) and from monomer (AM), said monomer (M2) having the formula (IV) below:

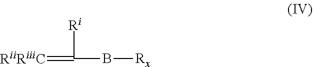

wherein:
Rⁱ is selected from the group consisting of H, —COOH, —CH₂OOOH or an alkyl group, wherein the alkyl group is preferably a methyl group;
Rⁱⁱ and Rⁱⁱⁱ being the same or different from each other, may be selected from a hydrogen atom or from a linear or branched alkyl group having 1 to 6 carbon atoms, or can be —COOH group; B is a linkage selected from the group consisting of a —C(O)—O— group and a —C(O)—NH— group;
Rₓ is selected from a hydrogen atom or a linear or branched C₃-C₂₀ hydrocarbon chain moiety comprising at least one functional groups selected from the group consisting of ether (—O—), heterocyclic group, sulfonic acid group (—SO₃H), salt of sulfonic acid group (˜SO₃Cat), phosphonic acid group (—PO₃H₂), salt of phosphonic acid group (—PO₃Cat₂), phosphoric acid group (—OPO₃H₂), and salt of a phosphoric acid group (—OPO₃Cat₂), with Cat being a monovalent cation preferably selected from alkali metals cations, more preferably is selected from Na⁺, K⁺ and Li⁺;
monomer (M3), being a hydrophobic or amphiphilic monomer selected from the group consisting of:
   alkyl esters of maleic anhydride and (meth)acrylic acid, such as monomethyl maleic anhydride ester, dimethyl maleic anhydride ester, monoethyl maleic anhydride ester, diethyl maleic anhydride ester, methyl (meth)acrylate, ethyl (meth)acrylate, propyl (meth)acrylate, isopropyl (meth)acrylate, n-butyl (meth)acrylate, 2-ethylhexyl (meth)acrylate, n-hexyl (meth)acrylate, n-octyl (meth)acrylate,
   hydroxyalkyl esters of maleic anhydride and (meth)acrylic acid, such as monohydroxyethyl maleic anhydride ester, dihydroxyethyl maleic anhydride ester, hydroxyethyl (meth)acrylate, hydroxypropyl (meth)acrylate, hydroxybutyl (meth)acrylate
   ethoxylates and propoxylates that derive from maleic anhydride, such as such as poly(propylene oxide)-b-poly(ethylene oxide) maleic acid half ester or diester alkyl-poly(ethylene oxide) maleic acid half ester or diester,
   ethoxylates and/or propoxylates that derive from the ethoxylation and/or propoxylation of hydroxyalkyl (meth)acrylic acid, such as poly(propylene oxide)-b-poly(ethylene oxide)-ethyl (meth)acrylate
   ethoxylates and/or propoxylates that derive from the (trans)esterification of (meth)acrylic acid and esters such as poly(propylene oxide)-b-poly(ethylene oxide) (meth)acrylate and alkyl-poly(ethylene oxide) (meth)acrylate
   Vinyl ethers such as methyl vinyl ether, ethyl vinyl ether, propyl vinyl ether, 2-ethylhexyl vinyl ether, vinyl cyclohexyl ether, dodecyl vinyl ether, 2-(diethylamino)ethyl vinyl ether, 2-(di-n-butylamino)ethyl vinyl ether allyl ethers such as methyl vinyl ether, ethyl vinyl ether, propyl vinyl ether, 2-ethylhexyl vinyl ether,
   vinyl esters, such as vinyl acetate or vinyl propionate alkyl-substituted acrylamides such as N-tert-butyl acrylamide or N-methyl (meth)acrylamide.

Polymer (P) can be obtained by radical copolymerization of a mixture of at least one monomer (AA), at least one monomer (AM) and optionally at least one monomer (M) as above defined, to provide a polymer (P—H), followed by neutralization of the acid groups of the recurring units derived from monomer (AA), wherein the neutralization of acid groups is carried out either with a salt [salt (S)] including a monovalent cation, preferably an alkaline metal salt, in a suitable solvent, or with ammonia.

The salt (S) can be any salt capable of neutralizing the acid groups. In some embodiments, the salt (S) is a lithium salt selected from the group consisting of lithium carbonate, lithium hydroxide, lithium bicarbonate, and combinations thereof, preferably lithium carbonate. In some embodiments, the lithium salt is free of lithium hydroxide.

The solvent for use in the step of neutralization of polymer (P—H) can be any solvent capable of dissolving the salt (S) or ammonia and the resulting polymer (P). Preferably, the solvent is selected from at least one of an aqueous solvent, such as water, NMP, and alcohols, such as, for example, methanol, isopropanol, and ethanol. Most preferably, the solvent is an aqueous solvent. Still more preferably the solvent is water.

Preferably the content of the salt (S) in the solvent ranges from 0.5 to 10 wt %, preferably from 1 to 5 wt %, based on the total weight of the solvent and the salt (S).

In some embodiments wherein the salt (S) is a lithium salt, the concentration of the lithium salt in the solvent provides at least 0.25 eq, 0.5 eq, 0.8 eq, 1 eq, 1.5 eq, 2 eq, 2.5 eq, 3 eq, 4, eq of lithium to acid groups.

In some embodiments, the concentration of the lithium salt in the solvent provides at most 5 eq, preferably at most 4, eq of lithium to acid groups.

According to said embodiments, the polymer (P) comprises recurring units derived from the lithiated form of the at least one α,β-ethylenically unsaturated carboxylic acid monomer.

The content of polymer (P) in the solution after neutralization, based on the total weight of the solvent and the polymer (P), ranges from 0.5 to 40 wt %, preferably from 2 to 30 wt %, more preferably 4 to 20 wt %.

In a preferred embodiment, a lithium salt of polymer (P), namely polymer (P—Li) was prepared by adding an amount of LiOH to at least partially fully neutralize an aqueous solution containing about 10 wt % polymer (P—H). The resulting solution had a pH in the range of 6.5 to 9, preferably in the range of 7 to 8 and contained approximately 10 wt % of polymer (P—Li).

The neutralized polymer solution has advantages in the processing and dispersing ability of the slurry because neutralized polymer shows increased viscosity. Moreover, polymer (P—Li) has a pH more compatible with lithiated silicon types that usually show better performance if processed with slurry having a pH higher than 7.

According to an embodiment of the present invention, polymer (P) comprises at least one monomer (M1), which is an ethylenically unsaturated monomer carrying an unsaturated heterocyclic group having at least one nitrogen atom as above defined.

The “unsaturated heterocyclic group having at least one nitrogen atom” in monomer (M1) of formula (III) includes preferably a 5- to 6-membered aromatic cyclic group having at least one N in the ring and, such as:

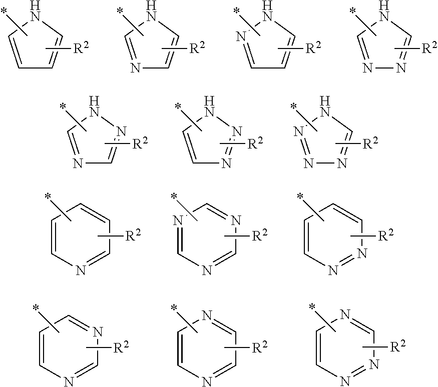

wherein * represent the tie point of the linkage A.

The linkage A and the residue R² may be attached to the heterocyclic group at any position, either on carbon or nitrogen atom.

The monomer (M1) may for example be:
vinylimidazole (Vim) of formula (IIIa):

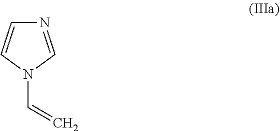

2-methyl-1-vinylimidazole of formula (IIIb)

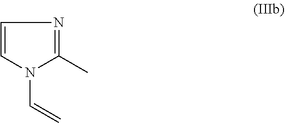

1-vinyl-1,2,4-triazole of formula (IIIc)

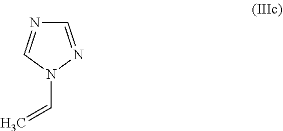

2-vinylpyrazine of formula (IIId)

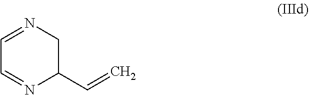

4-vinylpyridine of formula (IIIe)

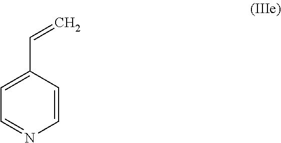

2-vinylpyridine of formula (IIIf)

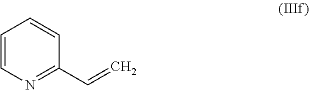

hydroxyl-(meth)acrylate imidazole derivative of formula (IIIg)

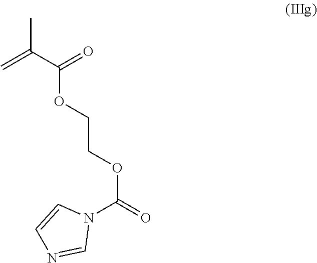 [SMILES: C=C(C)C(=O)OCCOC(=O)n1ccnc1]

The divalent spacer group A in formula (III) may typically be group —CO—NH—(CH₂)ₙ—, —CO—O—(CH₂)ₙ or —CO—O—(CH₂)ₙ—O—CO—, but any other covalent linker group may be contemplated, for example resulting from the reaction of a compound of formula (III-X):

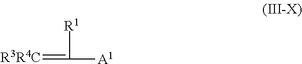

wherein R⁶, R⁸ and R⁹ are as above defined,
with a compound of formula (III-Y):

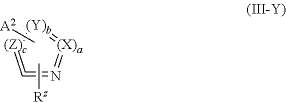

wherein R² is as above defined, A¹ and A² are two groups reacting together for forming a covalent bond.

For example, A² may be a —(CH₂)ₘ—NH₂ group wherein m is from 1 to 4, preferably 2 or 3. In that case, A¹ may be for example a carboxylic acid, an acid chloride, an anhydride or an epoxy.

According to another variant, A² may be a —(CH₂)ₘ—OH group wherein m is from 1 to 4, preferably 2 or 3. In that case, A¹ may be for example a carboxylic acid, an acid chloride, an anhydride or an ester.

According to this embodiment, the polymer (P) is a polymer as obtained by copolymerizing monomers (AA), (AM) and at least one monomer (M1) to obtain polymer (P—H), namely having the structure that is obtained via such a polymerization, followed by neutralization of the acid groups of the recurring units derived from monomer (AA); but the polymer (P) is not necessarily obtained by this process. As an alternative, the polymer (P—H) may for example be obtained by a first step (E1) of copolymerizing monomer (AA), monomer (AM) and a compound of formula (III-X) leading to a polymer (PO) and then a second step (E2) of post-grafting of the polymer (PO) by a reaction with compound (III-Y).

When A² is a —(CH₂)ₘ—NH₂ group in the compound (III-Y) used in step (E2), the compound (III-X) used in the step (E1) may advantageously be selected from: additional acrylic or methacrylic acid, or ester thereof; maleic anhydride; vinylbenzyl chloride; glycidylmethacrylate; and (blocked) isocyanatoethyl methacrylate.

When A² is a —(CH₂)ₘ—OH group in the compound (III-Y) used in step (E2), the compound (III-X) used in the step (E1) may advantageously be selected from additional acrylic acid, methacrylic acid, maleic anhydride or their esters.

Besides, a quaternization of all or part of the imidazole functions of polymer (P—H) may occur, resulting from a quaternization of all or part of the monomers and/or form a post-quaternization of all or part of the imidazole functions of the polymer.

According to another embodiment of the present invention, polymer (P) comprises at least one monomer (M2) of formula (IV) as above defined.

The “heterocyclic group” in residue Rₓ of monomer (M2) includes saturated heterocyclic group having at least one nitrogen atom compound, such as imidazolidinone.

According to a first variant wherein B in formula (IV) is a —C(O)—O— group, the monomer (M2) may for example be a compound of formula (IVa)

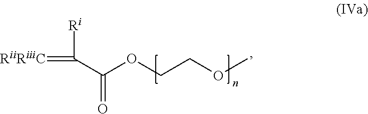

a compound of formula (IVb)

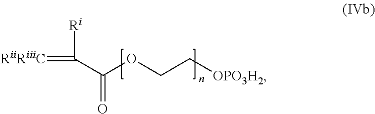

a compound of formula (IVc)

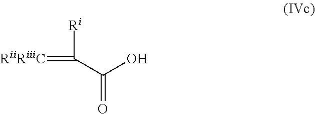

wherein in the formulae (IVa) to (IVc) Rⁱ, Rⁱⁱ and Rⁱⁱⁱ are as above defined, and n is an integer from 1 to 40.

According to a second variant wherein B in formula (IV) is a —C(O)—NH— group, the monomer (M2) may for example be a compound of formula (IVd)

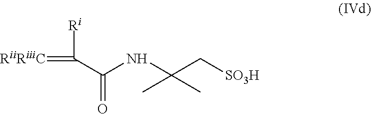

or a compound of formula (IVe)

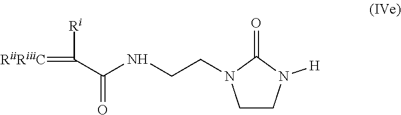

wherein in the formulae (IVd) and (IVe) Rⁱ, Rⁱⁱ and Rⁱⁱⁱ are as above defined.

According to this embodiment, the polymer (P) is a polymer as obtained by copolymerizing monomers (AA), (AM) and at least one monomer (M2), to obtain polymer (P—H), namely having the structure that is obtained via such a polymerization, followed by neutralization of the acid groups of the recurring units derived from monomer (AA); but the polymer (P—H) is not necessarily obtained by this process.

According to another embodiment, polymer (P) may comprise one or more further monomers (M3) as above defined.

Advantageously the proportion in moles of monomers (M3) in polymer (P) is below 5% by moles.

The at least one polymer (P) may further comprise below 1% by moles of one or more further crosslinking monomers (XL-M) comprising at least two ethylenic unsaturations.

In this embodiment where additional monomers (XL-M) are present in polymer (P), said crosslinking monomers may be chosen from N,N′-methylenebisacrylamide (MBA), N,N′-ethylenebisacrylamide, polyethylene glycol (PEG) diacrylate, triacrylate, divinyl ether, typically trifunctional divinyl ether, for example tri(ethylene glycol) divinyl ether (TEGDE), N-diallylamines, N,N-diallyl-N-alkylamines, the acid addition salts thereof and the quaternization products thereof, the alkyl used here being preferentially (C₁-C₃)-alkyl; compounds of N,N-diallyl-N-methylamine and of N,N-diallyl-N,N-dimethylammonium, for example the chlorides and bromides; or alternatively ethoxylated trimethylolpropane triacylate, ditrimethylolpropane tetraacrylate (DiTMPTTA), divinylbenzene (DVB), ethoxylated or propoxylated bisphenol A diacrylate, dipropylene glycol diacrylate (DPGDA), tripropylene glycol diacrylate (TPGDA), propoxylated di(meth)acrylate, butyloxylated di(meth)acrylate, dimethylacrylamide, 1, 4-butanediol dimethacrylate (BDDMA), 1,6-hexanediol dimethacrylate (HDDMA), 1,3-butylene glycol dimethacrylate (BGDMA), and derivatives thereof.

The proportion in moles of monomers (XL-M) cannot exceed 1% by moles of the total moles of monomers present in polymer (P) to avoid gel formation and viscosity increase. Advantageously the proportion in moles of monomers (XL-M) is below 0.5% by moles.

According to said embodiment, polymer (P) obtained by a process comprising a polymerization step that further includes monomer (XL-M) is at least partially crosslinked.

In one preferred embodiment of the invention, there are no monomers (M3) or (XL-M) in the polymer (P), which means that polymer (P—H) is obtained by radical copolymerization of a mixture consisting essentially of, notably consisting of:
at least one [monomer (AA)] as above defined;
at least one [monomer (AM)] as above defined; and
at least monomer (M) selected from monomer (M1) and monomer (M2) to provide polymer (P—H), followed by neutralization of the acid groups of the recurring units derived from monomer (AA).

Typically, the polymer (P) is obtained by radical copolymerization of a mixture of:
at least one monomer (AA),
at least one monomer (AM),
at least monomer (M) selected from monomer (M1), monomer (M2) and monomer (M3) and,
optionally at least one monomer (XL-M),
in the presence of a source of free radicals, followed by neutralization of the acid groups of the recurring units derived from monomer (AA).

Any source of free radicals can be used. It is possible in particular to generate free radicals spontaneously, for example by increasing the temperature, with appropriate monomers, such as styrene. It is possible to generate free radicals by irradiation, in particular by UV irradiation, preferably in the presence of appropriate UV-sensitive initiators. It is possible to use initiators or initiator systems of radical or redox type. The source of free radicals may or may not be water-soluble. It may be preferable to use water-soluble initiators or at least partially water-soluble initiators.

Generally, the greater the amount of free radicals, the more easily the polymerization is initiated (it is promoted) but the lower the molar masses of the copolymers obtained. Use may in particular be made of the following initiators:
peroxides, such as: hydrogen peroxides, tert-butyl hydroperoxide, cumene hydroperoxide, t-butylperoxyacetate, t-butyl peroxybenzoate, t-butyl peroxyoctoate, t-butyl peroxyneodecanoate, t-butyl peroxyisobutyrate, lauroyl peroxide, t-amyl peroxypivalate, tbutyl peroxypivalate, dicumyl peroxide, benzoyl peroxide, sodium persulfate, potassium persulfate or ammonium persulfate,
azo compounds, such as: 2,2′-azobisisobutyronitrile, 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(hydroxyethyl)propionamide], 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramide), 2,2′-azobis{2-methyl-N-[1,1-bis(hydroxymethyl)-2-hydroxyethyl]propionamide}, 2,2′-azobis{2-methyl-N—[1,1-bis(hydroxymethyl)ethyl]propionamide}, 2,2′-azobis[2-methyl-N-(2-hydroxyethyl)propionamide] or 2,2′-azobis(isobutyramide) dihydrate,
redox systems comprising combinations, such as: mixtures of hydrogen peroxide, alkyl peroxide, peresters, percarbonates, persulfates and the like and of any iron salt, titanous salt, zinc formaldehydesulfoxylate or sodium formaldehydesulfoxylate, and reducing sugars,
alkali metal or ammonium persulfates, perborates or perchlorates, in combination with an alkali metal bisulfite, such as sodium metabisulfite, and reducing sugars, and
alkali metal persulfates in combination with an arylphosphinic acid, such as benzenephosphonic acid and others of a like nature, and reducing sugars.

The polymerization temperature can in particular be between 25° C. and 95° C. The temperature can depend on the source of free radicals. If it is not a source of UV initiator type, it will be preferable to operate between 50° C. and 95° C., more preferably between 60° C. and 80° C. Generally, the higher the temperature, the more easily the polymerization is initiated (it is promoted) but the lower the molar masses of the copolymers obtained.

According to a preferred embodiment of the present invention, a polymer (P—H) is obtained by radical polymerization of one monomer (AA), one monomer (AM), and one monomer (M) in the presence of a source of free radicals, in order to obtain a polymer comprising recurring units derived from monomer (AA) recurring units derived from monomer (AM) and recurring units derived from monomer (M).

Polymer (P—H) can also be prepared by any controlled radical polymerization technique. Among these, reversible addition-fragmentation chain transfer (RAFT) and macromolecular design via inter-exchange of xanthate (MADIX) can be mentioned.

The use of RAFT or MADIX controlled radical polymerization agents, hereinafter referred to as “RAFT/MADIX agents”, has been disclosed for instance WO 98/058974 A (RHODIA CHIMIE) 30 Dec. 1998 and WO 98/01478 A (E.I. DUPONT DE NEMOURS AND COMMONWEALTH SCIENTIFIC AND INDUSTRIAL RESEARCH ORGANIZATION) 15 Jan. 1998.

Preferably, the polymer (P—H) is obtained by radical copolymerization of a mixture having the following molar ratio, based on the total quantity of monomer (AA), monomer (AM) and monomer (M):
monomer (AA): from 5 to 95%, notably from 5 to 50%, preferably from 20 to 40%,
monomer (AM): from 25 to 90%, preferably from 25 to 90%, more preferably from 60 to 80%,
monomer (M): from 0.1 to 50%, for example from 1 to 30%, notably from 1 to 20% and even 2 to 15%.

As a consequence, polymer (P) preferably comprises:
from 5 to 95%, notably from 5 to 50%, preferably from 20 to 40% of recurring units derived from monomer (AA) in neutralized form,
from 25 to 90%, preferably from 25 to 90%, more preferably from 50 to 80% of recurring units derived from monomer (AM), and
from 0.1 to 50%, for example from 1 to 30%, notably from 1 to 20% and even 2 to 15% of recurring units derived from monomer (M), all the aforementioned % by moles being referred to the total moles of recurring units of the polymer (P).

Besides, the polymer (P) according to the invention has a weight average molecular weight of about 500 kDa to 10000 kDa.

According to a preferred embodiment, polymer (P) is a statistical (random) copolymer having a weight average molecular weight of about 500 kDa to 10000 kDa, which is obtained by radical polymerization of a mixture of monomer (AA), monomer (AM), and a monomer (M), preferably in a molar ratio of about:
from 20 to 40% of monomer (AA),
from 50 to 80% of monomer (AM), and
from 2 to 15% of monomer (M).

According to an embodiment of the invention, polymer (P) is a block copolymer obtained by controlled radical polymerization using RAFT/MADIX agents.

By “block copolymer” as used herein it is intended any controlled-architecture copolymer, including but not limited to true block polymers, which could be di-blocks, tri-blocks, or multi-blocks; branched block copolymers, also known as linear star polymers; comb; and gradient polymers. Gradient polymers are linear polymers whose composition changes gradually along the polymer chains, potentially ranging from a random to a block-like structure. Each block of the block copolymers may itself be a homopolymer, a random copolymer, a random terpolymer, or a gradient polymer.

According to a more preferred embodiment, polymer (P) is obtained by radical polymerization of an acrylic acid, an acrylamide and vinylimidazole of formula (IIIa), followed by neutralization of the acid groups of the recurring units derived from monomer (AA), preferably with LiOH.

### The Electrode-Forming Composition [Composition (Comp)]

The electrode forming composition [composition (Comp)] of the present invention includes one or more electrode active material. For the purpose of the present invention, the term “electrode active material” is intended to denote a compound that is able to incorporate or insert into its structure, and substantially release therefrom, alkaline or alkaline-earth metal ions during the charging phase and the discharging phase of an electrochemical device. The electrode active material is preferably able to incorporate or insert and release lithium ions.

The nature of the electrode active material in the electrode forming composition (Comp) of the invention depends on whether said composition is used in the manufacture of a negative electrode (anode) or a positive electrode (cathode).

In the case of forming a positive electrode for a Lithium-ion secondary battery, the electrode active material may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive electrode for a Lithium-ion secondary battery, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M2 metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In the case of forming a negative electrode for a Lithium-ion secondary battery, the electrode active material may preferably comprise one or more carbon-based materials and/or one or more silicon-based materials.

In some embodiments, the carbon-based materials may be selected from graphite, such as natural or artificial graphite, graphene, or carbon black. These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide, silicon oxide and lithiated silicon.

More particularly, the silicon-based compound may be silicon oxide or silicon carbide.

When present in the electrode active material, the silicon-based compounds are comprised in an amount ranging from 1 to 70% by weight, preferably from 5 to 30% by weight with respect to the total weight of the electro active compounds.

One or more optional electroconductivity-imparting additives may be added in order to improve the conductivity of a resulting electrode made from the composition of the present invention. Conducting agents for batteries are known in the art.

Examples thereof may include: carbonaceous materials, such as carbon black, graphite fine powder, carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt. % of the total solids in the electrode forming composition. In particular, for cathode forming compositions the optional conductive agent is typically from 0 wt. % to 10 wt. %, more preferably from 0 wt. % to 5 wt. % of the total amount of the solids within the composition.

For anode forming compositions which are free from silicon based electro active compounds the optional conductive agent is typically from 0 wt. % to 5 wt. %, more preferably from 0 wt. % to 2 wt. % of the total amount of the solids within the composition, while for anode forming compositions comprising silicon based electro active compounds it has been found to be beneficial to introduce a larger amount of optional conductive agent, typically from 0.5 to 30 wt. % of the total amount of the solids within the composition.

The surprising excellent dispersing ability shown by polymer (P), despite the very high molecular weight, makes polymer (P) suitable for use as binder in the preparation of electrode-forming compositions having an excellent rheological profile, thus to stable slurry with no sedimentation for over 2 days without the use of a rheology modifier.

The amount of polymer (P) which may be used in the electrode-forming composition (Comp) is subject to various factors. One such factor is the surface area and amount of the active material, and the surface area and amount of any electroconductivity-imparting additive which are added to the electrode-forming composition. These factors are believed to be important because the polymer particles provide bridges between the conductor particles and conductive material particles, keeping them in contact.

Since the composition (Comp) does not include any rheology modifier such as CMC, and thanks to the excellent dispersing ability of polymer (P), the amount of polymer (P) in the electrode-forming composition can be raised.

The amount of polymer (P) in composition (Comp) is suitably of about 2 to 10%, preferably of about 3 to 5% of the total amount of the solids within the composition.

Thus, the high dispersing ability of polymer (P) allows to obtain compositions with higher binder content, with advantages in terms of higher efficiency, higher productivity and higher battery energy obtained.

The electrode-forming composition [composition (Comp)] of the present invention, thanks to the excellent dispersing ability of polymer (P), allows to obtain compositions with augmented total solid content (TSC), which is not trivial in the absence of rheology modifiers such as CMC.

The total solid content (TSC) of the composition (Comp) of the present invention is typically higher than 40%, preferably from 40 to 70 wt. % over the total weight of the composition (Comp). The total solid content of the composition (Comp) is understood to be cumulative of all non-volatile ingredients thereof, notably including polymer (P), the electrode active material and any solid, non-volatile additional additive.

The composition (Comp) may be prepared according to any method known to the skilled person.

In an embodiment, the electrode forming composition (Comp) of the present invention can be prepared by a process comprising the following steps:
Step 1: powder wetting; the powders (electrode active material, electroconductivity-imparting additives) are premixed with polymer (P) in a centrifugal mixer for 10′ to achieve powder wetting;
Step 2: homogenization; the wet powders obtained in step 1 are homogenized in centrifugal mixer for 10′ obtaining a slurry with final total solid content of at least 40% to achieve target viscosity (target range 2000-8000 cP at 10 s-1);
Step 3: slurry mixing; the slurry obtained in Step 2 is stirred in a disperser.

When the aqueous solution of polymer (P) is prepared separately and subsequently combined with an electrode active material and optional conductive material and other additives to prepare composition (Comp), an amount of water sufficient to create a stable solution is employed. The amount of water used may range from the minimum amount needed to create a stable solution to an amount needed to achieve a desired total solid content in an electrode mixture after the active electrode material, optional conductive material, and other solid additives have been added.

### The Electrode (E)

The electrode-forming composition (Comp) of the invention can be used in a process for the manufacture of an electrode [electrode (E)], said process comprising:
(i) providing a metal substrate having at least one surface;
(ii) providing an electrode-forming composition [composition (Comp)] as above defined;
(iii) applying the composition (Comp) provided in step (ii) onto the at least one surface of the metal substrate provided in step (i), thereby providing an assembly comprising a metal substrate coated with said composition (Comp) onto the at least one surface;
(iv) drying the assembly provided in step (iii);
(v) submitting the dried assembly obtained in step (iv) to a compression step to obtain the electrode (E) of the invention.

The metal substrate is generally a foil, mesh or net made from a metal, such as copper, aluminum, iron, stainless steel, nickel, titanium or silver.

Under step (iii) of the process of the invention, the electrode forming composition (Comp) is applied onto at least one surface of the metal substrate typically by any suitable procedures such as casting, printing and roll coating.

Optionally, step (iii) may be repeated, typically one or more times, by applying the electrode forming composition (Comp) provided in step (ii) onto the assembly provided in step (iv).

Under step (iv) of the process of the invention, drying may be performed either under atmospheric pressure or under vacuum. Alternatively, drying may be performed under modified atmosphere, e.g. under an inert gas, typically exempt notably from moisture (water vapour content of less than 0.001% v/v).

The drying temperature will be selected so as to effect removal by evaporation of the aqueous medium from the electrode (E) of the invention.

In step (v), the dried assembly obtained in step (iv) is submitted to a compression step such as a calendaring process, to achieve the target porosity and density of the electrode (E) of the invention.

Preferably, the dried assembly obtained at step (iv) is hot pressed, the temperature during the compression step being comprised from 25° C. and 130° C., preferably being of about 60° C.

Preferred target density for electrode (E) is comprised between 1.4 and 2 g/cc, preferably at least 1.55 g/cc. The density of electrode (E) is calculated as the sum of the product of the densities of the components of the electrode multiplied by their mass ratio in the electrode formulation.

In a further aspect, the present invention pertains to the electrode [electrode (E)] obtainable by the process of the invention.

Therefore the present invention relates to an electrode (E) comprising:
a metal substrate having at least one surface, and
directly adhered onto at least one surface of said metal substrate, at least one layer consisting of a composition comprising, preferably consisting of:
a) at least one polymer (P),
b) an electrode active material,
c) an aqueous solvent, and
d) optionally at least one electroconductivity-imparting additive.

The composition directly adhered onto at least one surface of said metal substrate corresponds to the electrode forming composition (Comp) of the invention wherein the aqueous solvent has been at least partially removed during the manufacturing process of the electrode, for example in step (iv) (drying) and/or in the compression step (v). Therefore all the preferred embodiments described in relation to the electrode forming compositions (Comp) of the invention are also applicable to the composition directly adhered onto at least one surface of said metal substrate, in electrodes of the invention, except for the aqueous medium removed during the manufacturing process.

In a preferred embodiment of the present invention, the electrode (E) is a negative electrode. More preferably, the negative electrode comprises a silicon based electro active material.

In a further preferred embodiment, the present invention relates to a negative electrode comprising, based on the total weight of the electrode:
0.5 to 15 wt. %, preferably 0.5 to 10 wt. % of the polymer (P),
45 to 95 wt. %, preferably 70 to 90 wt. % of the carbon-based material,
3 to 50 wt. %, preferably 10 to 50 wt. % of the silicon-based material, and
0 to 5 wt. %, preferably 0.5 to 2.5 wt. %, more preferably about 1 wt. % of the electroconductivity-imparting additive.

The Applicant has surprisingly found that the electrode according to the present invention is endowed with good mechanical properties and impressive cycle stability.

In addition to this, the binder comprising the polymer (P) of the present invention shows higher adhesion to current collector compared to SBR/CMC binders, but also to binders comprising polymer (P) and a rheology modifier such as CMC and to salified PAA.

The electrode (E) of the invention is thus particularly suitable for use in electrochemical devices, in particular in secondary batteries.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXAMPLES

### Raw Materials

AA: Acrylic Acid available from Aldrich;
AM: Acrylamide monomer (50% water solution) available from SNF;
VIm: vinylimidazole monomer available from Aldrich;
Transfer agent: freshly prepared 1% wt. solution in ethanol of MADIX-type transfer agent available as Rhodixan A1 from Solvay;
Sodium persulfate in powder form available from VWR; (10% wt. water solution was prepared just before the polymerization experiment);
Sodium formaldehydesulfoxylate in powder form available from Aldrich;
(10% wt. water solution was prepared just before the polymerization experiment);
V-50 initiator): (2,2′-Azobis(2-methyl-propionamidine) dihydrochloride) available in powder form from Aldrich; (10% wt. water solution was prepared just before the polymerization experiment);
Lithium hydroxide monohydrate (purity 98%) available from Sigma-Aldrich;
Chemically doped KSC-7144 SiOx having specific capacity of 2100 mAh/g available from Shin-Etsu;
Graphite, ACTILION GHDR from Imerys S.A.;
Carbon black (CB), available as SC45 from Imerys S.A.;
Carboxymethylcellulose (CMC), available as MAC 500LC from Nippon Paper;
Electrolyte mixture of LiPF6 1M in EC/DMC 1/1 v/v with 2% wt. VC and 10% wt. F1EC, from Solvionic.
C1020R-H Copper foil from Hohsen 10 μm thick
SBR BM480B commercially available from Zeon

### Synthesis Procedure of Polymer (P-1H)

The synthesis process was conducted in a thermally isolated reactor to minimize the heat exchange with surrounding (Thermos like flask). The reactor was equipped with a lid containing multiple entries into which were installed a small reflux system, a mechanical stirring system, a nitrogen purge line and a raw materials feed line. In a first step, all monomers, solvent (water) and a transfer agent, were charged into the reactor and kept under stirring and nitrogen purging for around 1 hour at room temperature. Then, the redox type initiator was added to the reaction mixture. The thermal initiator was also added at same time into the reaction mixture. The initiator was homogenized in the reaction mixture for few minutes with mechanical stirring, then the stirring and nitrogen purge were stopped.

An increase of the reaction mixture temperature from room temperature up to around 80-90° C. was obtained within around half to one hour time as an exothermic effect. Then, the reaction mixture was maintained in the reaction flask for further 24 hours. Aqueous solution of polymer (P) were thus obtained.

The charges of the reagents used for polymers (P-1H), (P-2H) and (P-3H) synthesis are given in Table 1.

TABLE 1

| | Quantities | Quantities | Quantities |
|---|---|---|---|
| | (Monomers | (Monomers | (Monomers |
| | molar | molar | molar |
| | ratio %) | ratio %) | ratio %) |
| Raw material | P-1H | P-2H | P-3H |
| Water | 871.6 g | 689.4 g | 871.2 g |
| (solvent) | | | |
| AA | 117.8 g | 100.8 g | 118.5 g |
| | (31.4%) | | (31.6%) |
| AM | 478.5 g | 398.5 g | 478.5 g |
| | (64.7%) | | (64.7%) |
| VIm | 18.0 | | 18.2 g |
| | (3.9%) | | (3.7%) |
| transfer agent | 5.20 g | 4.12 g | 5.21 g |
| Sodium | 3.00 g | 2.40 g | 3.00 g |
| persulfate | | | |
| Sodium | 1.50 g | 1.20 g | 1.50 g |
| formaldehyde | | | |
| sulfoxylate | | | |
| V-50 initiator | 4.50 g | 3.60 g | 4.50 g |

Mw, Solid content and residual monomers of the obtained polymers are provided in Table 2.

TABLE 2

| | | | Example | | |
|---|---|---|---|---|---|
| Properties | Method | Unit | P-1H | P-2H | P-3H |
| Molecular weight Mw | SEC MALS | Mg/mol | 1.7 | 1.4 | 2.0 |
| Solid Content (130° C.; | Gravimetric | % wt. | 25 | 25 | 25 |
| 1 hour; 1 g) | | | | | |
| Residual monomers | HPLC/ | % | <0.5 | <0.5 | <0.5 |
| (total) | NMR | | | | |

### Procedure for Preparation of Water Solution of Lithiated Polymer (P)

Polymer (P-1H), (P-2H) and (P-3H) aqueous solutions obtained as above described were titrated with a LiOH aqueous solution (4.25% by weight of LiOH in water) using a titrator T5 from Mettler Toledo until pH 7.5. Solutions with final lithiated P-1, P-2 and P-3 polymers concentration in water of 7.5 or 5 wt. % were prepared.

### Evaluation of the Rheology and Dispersing Ability of Lithiated Polymer (P)

Evaluation of the dispersing ability of polymer P-1 was made using an aqueous formulation comprising CB and the polymer P-1, in comparison with aqueous formulations having the same viscosity and comprising CB alone, CB with CMC, and CB with CMC and polymer P-1.

The aqueous formulations were submitted to orbitary mixing (Thinky ARE 250) for a sequence of 2000 rpm for 10 min. The dispersion state of the carbon black was assessed by optical microscopy. The results are described in the Table 3 below.

TABLE 3

| | Composition | |
|---|---|---|
| Formulation | (wt %) | Dispersion state |
| 1: CB/P-1 | 0.67/4.1 | Well-dispersed CB |
| 2: CB/CMC/P-1 | 0.67/0.67/2.6 | Dispersed CB with a few aggregates |
| 3: CB/CMC | 0.67/1.0 | Mixture of dispersed CB with |
| | | numerous large aggregates |
| 4: CB | 0.67 | Completely aggregated CB |

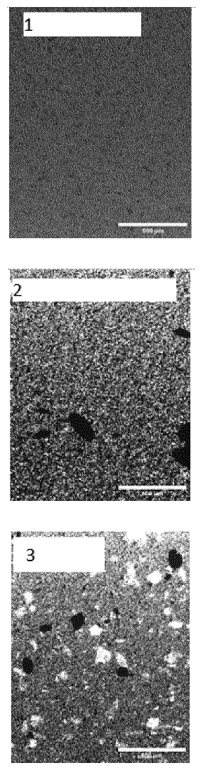

The microscopy images of formulations 1 to 3 are reported in FIG. 1.

The results show that the formulation comprising only the polymer dispersant of the invention has a better dispersion of the carbon black than the formulation also including CMC and a much better dispersion in comparison with the formulation comprising CMC alone.

The rheology of the aqueous formulation comprising polymer P-1 (0.67 wt %) and CMC (2.6 wt %), used to prepare the formulation 2, was that of a shear-thinning fluid with a well-defined low-shear plateau viscosity.

The Applicant demonstrated that an aqueous formulation with a similar viscosity can be obtained by only using P-1 at 4.1 wt %.

The low-shear viscosity taken at a shear rate of 0.1 s-1 is given in Table 4.

TABLE 4

| | Composition | Shear rate | Viscosity |
|---|---|---|---|
| Component | (wt %) | (s − 1) | (Pa · s) |
| CMC/P-1 | 0.67/2.6 | 0.1 | 3.8 |
| P-1 | 4.1 | 0.1 | 3.7 |

Therefore, the use of the polymer dispersant according to the present invention allows using formulations with higher amounts of binder without affecting the rheology of the binder itself.

### Zeta Potential Characterization

Zeta potential measurements were made on very dilute suspensions of CB, CB/CMC and CB/polymer dispersant of the invention.

Polymer dispersant solutions were diluted to 0.01 wt. % and left to stir 48 hr. Then, carbon black was added (0.01 wt. %) and dispersed by ultrasonic bath for 30 min. Results are given in Table 5.

TABLE 5

| | Composition | | |
|---|---|---|---|
| Component | (wt %) | pH | ZP (mV) |
| CB | 0.01 | 7.5 | −36 |
| CB/CMC | 0.01/0.01 | 7.7 | −66 |
| CB/CMC | 0.01/0.1 | 7.4 | −61 |
| CB/P-1 | 0.01/0.01 | 8.3 | −68 |
| CB/P-1 | 0.1/0.1 | 8.2 | −71 |
| CB/P-2 | 0.01/0.01 | 8.0 | −65 |
| CB/P-2H | 0.01/0.01 | 5.3 | −41 |
| CB/P-3 | 0.01/0.01 | 8.2 | −52 |
| CB/P-3H | 0.01/0.01 | 5.1 | −33 |

Suspension with CB only shows aggregation of the particles and rapid sedimentation, hence the electrostatic repulsion of the CB particles is insufficient to keep them stable at this pH.

When CMC or the polymer dispersant is added to CB, the zeta potential values are significantly higher, suggesting that a large electrostatic repulsion results from the combination of CB and polymer, leading to a good dispersion.

For non-salified polymers with CB, the ZP are close to that of the CB only.

Microscopic observation of non-salified polymers with CB shows large aggregates, that is, the dispersing ability of the non-salified polymers is poor, coherent with the lower ZP values.

In contrast, the lithiated polymer dispersant of the invention with CB give high ZP in the 50-60 mV range or more.

### Preparation of Electrode-Forming Compositions and Negative Electrodes

Electrode-forming compositions and negative electrodes were prepared as detailed below using the following equipment:
Mechanical mixer: planetary mixer (Speedmixer) and high shear mechanical mixer of the Dispermat® series with inclined impeller;
Film coater/doctor blade: Elcometer® 4340 motorised/Zehntner; ZUA2000;
Vacuum oven: BINDER VD 23 with vacuum; and Roll press: precision 4″ hot rolling press/calender up to 100° C.

### Example 1—Terpolymer Anode 5% Binder

An aqueous composition was prepared by mixing 28.0 g of a 7.5% by weight solution of lithiated P-1 in water, 0.42 g of carbon black, 7.89 g of silicon oxide, 31.58 g of graphite and 32.1 g of deionized water. The mixture was homogenized by moderate stirring in a planetary mixer for 20 min and then mixed again by moderate stirring for 1 h. After 1 h, the shear was reduced and the slurry mixed again by low stirring.

A negative electrode was obtained by casting the composition thus obtained on a 10 μm thick copper foil with a doctor blade and drying the coating layer in an oven at temperature of 90° C. for about 70 minutes. The thickness of the dried coating layer was about 72 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 5 wt. % of P-1 and 1 wt. % of carbon black. Electrode E1 was thus obtained.

### Example 2—Terpolymer Anode 4% Binder

An aqueous composition was prepared by mixing 24.0 g of a 7.5% by weight solution of lithiated P-1 in water, 0.45 g of carbon black, 8.55 g of silicon oxide, 34.2 g of graphite and 32.8 g of deionized water. The mixture was homogenized by moderate stirring in a planetary mixer for 20 min and then mixed again by moderate stirring for 1 h. After 1 h, the shear was reduced and the slurry mixed again by low stirring.

A negative electrode was obtained by casting the composition thus obtained on a 10 μm thick copper foil with a doctor blade and drying the coating layer in an oven at temperature of 90° C. for about 70 minutes. The thickness of the dried coating layer was about 70 μm. The electrode was then hot pressed at 60° C. in a roll press to achieve target density of 1.6 g/cc. The resulting negative electrode had the following composition: 19 wt. % of silicon oxide, 76 wt. % of graphite, 4 wt. % of P-1 and 1 wt. % of carbon black. Electrode E2 was thus obtained.

### Example 3—Terpolymer Anode 3% Binder

An aqueous composition was prepared by mixing 30.0 g of a 5% by weight solution of lithiated P-1 in water, 0.5 g of carbon black, 9.6 g of silicon oxide, 38.4 g of graphite and 21.5 g of deionized water. The mixture was homogenized by moderate stirring in a planetary mixer for 20 min and then mixed again by moderate stirring for 1 h. After 1 h, the shear was reduced and the slurry mixed again by low stirring.

A negative electrode was obtained by casting the composition thus obtained on a 10 μm thick copper foil with a doctor blade and drying the coating layer in an oven at temperature of 90° C. for about 70 minutes. The thickness of the dried coating layer was about 68 μm. The electrode was then hot pressed at 60° C. in a roll press to achieve target density of 1.6 g/cc. The resulting negative electrode had the following composition: 19.2 wt. % of silicon oxide, 76.8 wt. % of graphite, 3 wt. % of P-1 and 1 wt. % of carbon black. Electrode E3 was thus obtained.

### Comparative Example CE1: Negative Electrode Including Styrene/Butadiene Rubber (SBR) and Carboxymethyl Cellulose (CMC)

An aqueous composition was prepared by mixing 29.0 g of a 2% by weight solution of CMC, in water, and 0.58 g of carbon black; after moderate stirring in planetary mixer for 10 min, 11.14 g of silicon oxide 44.5 g of graphite and 11.68 g of deionized water were added. The mixture was homogenized by moderate stirring in a planetary mixer for 10 min and then mixed again by moderate stirring for 1 h. After about 1 h of mixing, 3.06 g of SBR suspension was added to the composition and mixed again by low stirring for 1 h.

A negative electrode was obtained by casting the composition thus obtained on a 10 μm thick copper foil with a doctor blade and drying the coating layer in an oven at temperature of 90° C. for about 70 minutes. The thickness of the dried coating layer was about 69 μm. The electrode was then hot pressed at 60° C. in a roll press to achieve target density of 1.6 g/cc. The resulting negative electrode had the following composition: 19.2 wt. % of silicon oxide, 76.8 wt. % of graphite, 2 wt. % of SBR, 1 wt. % of CMC and 1 wt. % of carbon black. Electrode CE1 was thus obtained

### Comparative Example 2—Terpolymer Anode 5% Binder Including Terpolymer and CMC

An aqueous composition was prepared by mixing 19.0 g of a 2% by weight solution of CMC, in water, 0.38 g of carbon black, 7.14 g of silicon oxide, 28.58 g of graphite and 24.6 g of deionized water. After moderate stirring in the planetary mixer for 10 min, 20.27 g of a 7.5% solid content solution in water of polymer P-1 was added. The mixture was homogenized by moderate stirring in a planetary mixer for 10 min and then mixed again by moderate stirring for 1 h. After 1 h, the shear was reduced and the slurry mixed again by low stirring.

A negative electrode was obtained by casting the composition thus obtained on a 10 μm thick copper foil with a doctor blade and drying the coating layer in an oven at temperature of 90° C. for about 70 minutes. The thickness of the dried coating layer was about 74 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 4 wt. % of P-1, 1 wt. % of CMC and 1 wt. % of carbon black. Electrode CE2 was thus obtained.

### Adhesion Test

The peeling tests were performed in order to evaluate the adhesion of the electrode composition coating onto the metal support. The test was performed on the electrodes prepared as described above, following the procedure of ASTM D903, working at a speed of 300 mm/min at 25° C.

The results are shown in Table 6.

TABLE 6

| Electrode | Peeling strenght (N/m) |
|---|---|
| E1 | 24.1 |
| E2 | 18.4 |
| E3 | 5.9 |
| CE1 | 5.1 |
| CE2 | 17.6 |

The data in Table 2 show that the electrodes obtained according to the present invention have a satisfying adhesion to current collector. In particular, by comparing the adhesion of E2 and CE2, it is clear that the presence of CMC has no positive impact on adhesion.

### Manufacture of Batteries

Coin cells (CR2032 type, 20 mm diameter) were prepared in a glove box under an Ar gas atmosphere by punching a small disk of the negative electrode prepared according to E1, E2, E3, and CE1, CE2 together a balanced NMC positive electrode disk, purchased from CUSTOMCELLS.

The electrolyte used in the preparation of the coin cells was a mixture of 1M LiPF6 solution in EC/DMC 1/1 v/v with 2% wt VC and 10% wt F1 EC, from Solvionic; polyethylene separators (commercially available from Tonen Chemical Corporation) were used as received.

### Capacity Retention Testing

Full cell cycling stability at 1C C-rate (Open capacities were measured in triplicate and are shown in Table 7 below):

TABLE 7

| | | Capacity | Capacity |
|---|---|---|---|
| | | retention after | retention after |
| | Initial capacity | 100 cycles | 180 cycles |
| Electrode | (mAh/g) | (mAh/g) | (mAh/g) |
| E1 | 131 | 122 | 120 |
| E2 | 131 | 117 | 116.5 |
| E3 | 129 | 112 | 110 |
| CE1 | 88 | 32 | 23 |
| CE2 | 129.5 | 114 | 112 |

The results in Table 3 show that the electrodes according to the present invention have a better cycling stability than the electrodes comprising the same amount of polymer (P) and CMC.

Moreover, the performance of the battery is even improved by the use of higher amounts of the polymer (P) of the present invention, while it is known in the art that increasing the amount of SBR/CMC binders significantly reduces performance duet and/or increases electrical resistivity.

Therefore, the use of the polymer according to the present invention allows obtaining electrodes comprising higher amounts of binder, which results in improved performances of the batteries comprising said electrodes.

1. An acrylic polymer dispersant [polymer (P)] for dispersing powder particles in aqueous electrode-forming compositions, characterized by comprising:
(C) recurring units derived from at least one α,β-ethylenically unsaturated carboxylic acid monomer [monomer (AA)] in neutralized form; and
(D) recurring units derived from at least one (meth)acrylamide monomer [monomer (AM)]
wherein the polymer (P) has weight average molecular weight of about 500 kDa to 10000 kDa.

2. The polymer (P) according to claim 1, wherein monomer (AA) is a compound of formula (I): 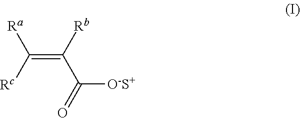
wherein R^{a}, R^{b} and R^{c}, equal to or different from each other, are independently selected from a hydrogen atom and a C₁-C₃ hydrocarbon group, and wherein S is a monovalent cation.

3. The polymer (P) according to claim 1, wherein monomer (AM) is a compound of formula (II): 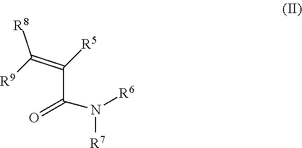
wherein
R⁵ represents a hydrogen atom or a methyl group,
R⁶ and R⁷ being the same or different from each other, may be selected from a hydrogen atom or from a linear or branched alkyl group having 1 to 6 carbon atoms,
R⁸ and R⁹, being the same or different from each other, may be selected from a hydrogen atom, from a linear or branched alkyl group having 1 to 6 carbon atoms, a carboxylic group or an amide group.

4. The polymer (P) according to claim 1, which further includes recurring units derived from at least one ethylenically unsaturated monomer (M), different from monomer (AA) and from monomer (AM), provided the total amount of monomer (AA) and/or monomer (AM) is at least 60% by moles with respect to the total moles of recurring units of polymer (P).

5. The polymer (P) according to claim 4, wherein monomer (M) is selected from the group consisting of:
monomer (M1), being an ethylenically unsaturated monomer carrying an unsaturated heterocyclic group having at least one nitrogen atom, said monomer (M1) having the formula (III) below: 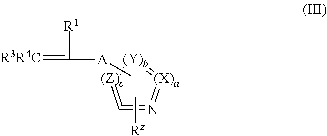
wherein:
R¹ is H or an alkyl group;
R² is H or an alkyl group;
R³ and R⁴, being the same or different from each other, may be selected from a hydrogen atom or from a linear or branched alkyl group having 1 to 6 carbon atoms;
A is a linkage selected from the group consisting of:
a single covalent bond; and
a spacer;
wherein X, Y and Z, independently from each other, are selected from a carbon atom or a nitrogen atom;
wherein a, b and c are, independently from each other, selected from the integer 1 to 2;
wherein each dashed-dotted line represents an optional double bond;
monomer (M2), different from monomer (AA) and from monomer (AM), said monomer (M2) having the formula (IV) below: 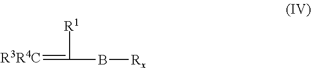
wherein:
Rⁱ is selected from the group consisting of H, —COOH, —CH₂COOH or an alkyl group;
Rⁱⁱ and Rⁱⁱⁱ being the same or different from each other, may be selected from a hydrogen atom or from a linear or branched alkyl group having 1 to 6 carbon atoms, or can be —COOH group;
B is a linkage selected from the group consisting of a —C(O)—O— group and a —C(O)—NH— group;
Rₓ is selected from a hydrogen atom or a linear or branched C₃-C₂₀ hydrocarbon chain moiety comprising at least one functional groups selected from the group consisting of ether (—O—), heterocyclic group, sulfonic acid group (—SO₃H), salt of sulfonic acid group (—SO₃Cat), phosphonic acid group (—PO₃H₂), salt of phosphonic acid group (—PO₃Cat₂), phosphoric acid group (—OPO₃H₂), and salt of a phosphoric acid group (—OPO₃Cat₂), with Cat being a monovalent cation;
monomer (M3), being a hydrophobic or amphiphilic monomer selected from the group consisting of:
alkyl esters of maleic anhydride and (meth)acrylic acid,
hydroxyalkyl esters of maleic anhydride and (meth)acrylic acid,
ethoxylates and propoxylates that derive from maleic anhydride,
ethoxylates and/or propoxylates that derive from the ethoxylation and/or propoxylation of hydroxyalkyl (meth)acrylic acid,
ethoxylates and/or propoxylates that derive from the (trans)esterification of (meth)acrylic acid and esters,
Vinyl ethers,
allyl ethers,
vinyl esters, and
alkyl-substituted acrylamides.

6. The polymer (P) according to claim 5, wherein monomer (M) is vinylimidazole (VIm) of formula (IIIa):

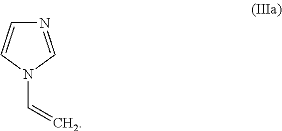

7. The polymer (P) according to claim 5, which comprises:
from 5 to 95% of recurring units derived from monomer (AA) in neutralized form,
from 25 to 90% of recurring units derived from monomer (AM), and
from 0.1 to 50% of recurring units derived from monomer (M),
all the aforementioned % by moles being referred to the total moles of recurring units of the polymer (P).

8. A process for manufacturing polymer (P) according to claim 1, comprising the radical copolymerization of a mixture of at least one monomer (AA), at least one monomer (AM) and optionally at least one monomer (M) to provide a polymer (P—H), followed by neutralization of the acid groups of the recurring units derived from monomer (AA), wherein the neutralization of acid groups is carried out either with a salt [salt (S)] including a monovalent cation, in a suitable solvent, or with ammonia.

9. An aqueous electrode-forming composition [composition (Comp)] for use in the preparation of electrodes for electrochemical devices, said composition being characterized by consisting of:
a) at least one polymer (P) according to claim 1;
b) an electrode active material,
c) an aqueous solvent, and
d) optionally at least one electroconductivity-imparting additive.

10. The aqueous electrode-forming composition [composition (Comp)] according to claim 9, wherein the amount of polymer (P) is of about 2 to 10% of the total amount of the solids within the composition.

11. The aqueous electrode-forming composition [composition (Comp)] according to claim 9, whose total solid content is higher than 40% over the total weight of the composition (Comp).

12. A process for preparing an electrode [electrode (E)], said process comprising:
(i) providing a metal substrate having at least one surface;
(ii) providing a composition (Comp) according to claim 9;
(iii) applying the composition (Comp) provided in step (ii) onto the at least one surface of the metal substrate provided in step (i), thereby providing an assembly comprising a metal substrate coated with said composition (Comp) onto the at least one surface;
(iv) drying the assembly provided in step (iii); and
(v) submitting the dried assembly obtained in step (iv) to a compression step to obtain the electrode (E).

13. An electrode [electrode (E)] obtained by the process according to claim 12.

14. An electrochemical device comprising at least one electrode (E) of claim 13.
